(19) United States
(12) Patent Application Publication
(10) Pub. No.: US 2014/0164896 A1
(43) Pub. Date: Jun. 12, 2014

(54) Method And System For Expanding And Collapsing Data Cells In A Spreadsheet Application

(71) Applicant: CAN DO GMBH, Munich (DE)

(72) Inventor: Thomas Schlereth, Munich (DE)

(73) Assignee: CAN DO GMBH, Munich (DE)

(21) Appl. No.: 13/706,378

(22) Filed: Dec. 6, 2012

(51) Int. Cl. G06F 17/24

(52) U.S. Cl. CPC G06F 17/246
USPC 715/217

(57) ABSTRACT

The invention relates to a method for expanding data cells in a spreadsheet or a report which is associated with a spreadsheet having a number of cells that are displayed in rows and columns wherein at least some of the cells may contain data which is member of a hierarchic structure comprising different hierarchic levels, the methods comprising the following steps:
detecting a user request to expand a certain cell, wherein the user request comprises the selection of a cell to be expanded,
further detecting a dragging movement performed by the user by means of an input means and
expanding the selected cell in reaction to the dragging movement, thereby displaying one or more cells proximate to the selected cell, depending on the length of the dragging movement.

### BACKGROUND

Spreadsheet software applications are frequently used by a vast number of users for processing, manipulating or displaying data or creating a so-called report. A typical spreadsheet usually comprises a limited number of cells which are arranged in rows and columns. Each of the cells may contain specific data, such as values, functions, formulas, strings or other data.

Many well-known spreadsheet applications, such as Microsoft®Excel®, allow making user defined reports or so-called Pivot-Tables from the actual spreadsheet data. For creating a report or Pivot-Table, respectively, any desired data of the spreadsheet may be selected and displayed in a separate table. Thereby, the data may be arranged in groups or processed as desired. The data included in the report or Pivot-Table is usually also displayed in individual cells which are arranged in rows and columns. Therefore, such a report or Pivot-Table is also referred to as a “spreadsheet” within this application.

Data, which is included in a single row or column of a spread sheet usually refers to a single type of information which may be summarized under a common header, such as “task”, “cost”, “time” or “amount”. If another category of information is to be added to a given spreadsheet, an additional row or column has to be created and inserted between existing rows and columns, respectively. As the number of rows and columns of a spreadsheet grows with the complexity of a project, the corresponding spreadsheet quickly becomes very large and confusing. For instance, if the costs of a task within a project are to be displayed in different currencies, such as USD, EUR or JPY, a separate row or column has to be provided in the spreadsheet for each currency. Thereby, the dimensions of a spreadsheet may grow excessively, which makes it difficult to read and to extract any desired information. Therefore, in order to improve clarity and readability of a large spreadsheet, the data belonging to the same category, like for instance “amount”, “time” or “kind” may be arranged in a group which is labelled with a common label. For example, a group labelled “U.S.A.” may be associated with up to 50 group members, namely one cell for each State of the Union. Thereby, a hierarchic structure is created which comprises cells of different hierarchy levels. In the precedent example, the group labelled “U.S.A.” would be of a higher hierarchy level, e.g. level “1”, and the group members of a lower hierarchy level, e.g. level “2”. The group members of level 2 may themselves comprise further members of a sub-group of a lower level, e.g. level “3”, etc.

The cells of a first level may also be referred to as “parent cells”, and the cells of the next lower level as “child cells” of the associated parent cell. The child cells of the second level may also be regarded as parent cells if they comprise further child cells of a lower level. Cells of the same hierarchy level may also be referred to as sibling cells.

As appropriate, a user may expand anyone of the parent cells to display the associated child cells of the next lower level or any other sub-level. A user may also collapse the parent cell such that the child cells are hidden and not displayed any more.

Well-known spreadsheet applications like Microsoft®Excel® provide small icons, like a framed “+” symbol or “−” symbol within the boundaries of a cell in order to expand or collapse that cell. However, if the hierarchy tree is very deep and comprises a large number of hierarchy levels, clicking on the small icons may become rather time consuming and annoying.

### SUMMARY OF THE INVENTION

The summary is provided to introduce a selection of concepts in a simplified form that are further described below in a detailed description. The summary is not intended to identify key features or essential features of the claimed subject-matter.

According to the invention, a method for expanding data cells in a spreadsheet or a report which is associated with the spreadsheet having a number of cells that are displayed in rows and columns, wherein at least some of the cells contain data entries which are member of a hierarchic structure comprising different hierarchic levels, comprises:
detecting a user request to expand a certain cell, wherein the user request comprises the selection of a cell to be expanded,
further detecting a dragging movement performed by the user by means of an input means and
expanding the selected cell in reaction to the dragging movement, thereby displaying one or more cells proximate to the selected cell, depending on the length of the dragging movement.

The input means may be a regular mouse, touchpad or touch screen, among others.

In order to select a cell to be expanded or collapsed, the user may click or double click on a desired cell, thereby pressing one or more buttons or keys, or he may enter any other command which is designed in the spreadsheet software application for that purpose. In order to perform a dragging movement, the user has to move the mouse or any other input means, thereby pressing a button or one or more keys, or he may enter any other preset command while moving the cursor on the screen.

In the specification, the term “expanding a cell” means that one or more cells are displayed, depending on the length of the dragging movement, which contain data of a different, in particular lower hierarchy level than the data contained in the expanded cell (parent cell).

According to an embodiment of the invention, when a user request to expand a certain cell and a subsequent dragging movement are detected, one or more entire lines or columns are added, each of which contains a child cell of the expanded parent cell. The other cells of the newly displayed rows or columns, respectively, may be automatically filled with data depending on the row and column to which the respective cell belongs to.

Displaying of new lines or columns preferably follows the position of the cursor. In a special embodiment of the invention, the new rows or columns are displayed exactly up to the position of the cursor. In that case, also partial rows and columns are displayed. In another embodiment of the invention, only entire rows and columns (in terms of width and height), respectively, are displayed during a dragging movement. A new row or column may be displayed for instance, when the cursor crosses a borderline of a cell or any other predetermined position.

When performing a straight dragging movement of a given length, like for instance a straight downward movement, a corresponding number of child cells are displayed, wherein the newly displayed child cells preferably contain data of the same hierarchy level, i.e. they are siblings.

If one or more of the child cells are themselves expandable, these cells may again be expanded. In order to expand a child cell, which is also a parent cell, there are different options which will be explained hereafter: According to a first embodiment of the invention, the user may change the direction of his dragging movement, thereby indicating that the latest displayed child cell shall also be expanded. According to a second embodiment of the invention, a dragging movement may also be briefly stopped or paused so as to indicate that a child cell shall be expanded. According to a third embodiment of the invention, the user may just perform a straight dragging movement in a given direction, e.g. a slanted or diagonal movement, thereby indicating that each child cell, which is also a parent cell, shall also be expanded. Alternatively, one or more keys may be pressed or any other command may be entered in order to expand the current cell at the location of the cursor.

In case of the first or third embodiment of the invention, the direction of a dragging movement is detected and, depending on the direction of the dragging movement, either one or more child cells containing data of the same hierarchy level (sibling cells) are displayed or one of the newly displayed cells is expanded. As an example, the user may for instance perform a downward dragging movement, thereby revealing one or more child cells of the same hierarchy level and, at the position of one of the child cells, change the direction of his dragging movement, like for instance in an inclined angle, thereby expanding this cell and revealing another child cell of the next lower level. The user may then continue the inclined dragging movement, thereby requesting the latest displayed cell to be further expanded. Or he may change the direction of his dragging movement back to the “standard direction” (for instance downward or sideward) and reveal one or more new cells of the same hierarchy level as the latest cell. The same method may be used for expanding columns equivalently.

In case of the second embodiment of the invention, the user may, during the process of expanding a parent cell and revealing one or more child cells of the next lower hierarchy level, briefly stop his dragging movement for at least a predetermined time, thereby indicating that he desires to expand one of the child cells. On detecting such a user request, the child cell is expanded instantly or will be expanded on continuation of the dragging movement. The minimum pause time is preferably less than one second and may be about half a second for instance. After the stop, the user may continue his dragging movement in the same direction, thereby revealing one or more new cells of the same hierarchy level (but of a lower level than the first expanded cell).

As mentioned before, upon detection of the dragging movement, the selected cell is expanded, whereby one or more child cells are preferably displayed adjacent to the parent cell.

When expanding a cell, the formerly adjacent rows and columns, respectively, are preferably automatically moved aside to give room to the one or more new rows or columns including the child cells.

The present invention also relates to a computer readable storage medium comprising a software application for expanding data cells in a spreadsheet or a report, which is associated with a spreadsheet, having a number of cells that are displayed in rows and columns, wherein at least some of the cells contain data which is a member of a hierarchic structure comprising different hierarchic levels, the software application comprising a code which executes the steps of:
detecting a user request to expand a certain cell, wherein the user request comprises the selection of a cell to be expanded,
further detecting a dragging movement performed by the user by means of an input means and
expanding the selected cell in reaction to the dragging movement, thereby displaying one or more cells proximate to the selected cell, depending on the length of the dragging movement.

The software application is further adapted to execute, by means of a processor, one or more of the above-mentioned functions.

Finally, the present application relates to a system for expanding data cells in a spreadsheet or a report which is associated with a spreadsheet, comprising a processor and a computer readable storage medium as well as a software application configured to perform one or more of the above-mentioned actions using the processor.

### BRIEF DESCRIPTION OF THE DRAWINGS

FIG. 1 illustrates an exemplary computing architecture for a computer;

FIG. 2 illustrates an overview of a spreadsheet system;

FIG. 3 illustrates the expansion of data cells in a spreadsheet report, in accordance with the state of the art;

FIG. 4 illustrates the expansion of data cells in a spreadsheet report, in accordance with the state of the art;

FIG. 5 illustrates the expansion of data cells in a spreadsheet report, in accordance with the state of the art;

FIG. 6 illustrates the expansion of data cells in a spreadsheet report, in accordance with the present invention;

FIG. 7 illustrates the expansion of data cells in a spreadsheet report, in accordance with the present invention;

FIG. 8 illustrates the expansion of data cells in a spreadsheet report, in accordance with the present invention;

FIG. 9a,b,c illustrate different paths of a dragging movement for expanding data cells in accordance with the present invention;

FIG. 10 illustrates an exemplary spreadsheet report wherein several parent cells are expanded simultaneously;

FIG. 11 illustrates the expanded state of the spreadsheet of FIG. 10;

FIG. 12 illustrates the expansion of columns in a spreadsheet report, in accordance with the present invention;

FIG. 13 illustrates the expanded state of the spreadsheet of FIG. 12; and

FIG. 14 illustrates the expansion of data cells in a spreadsheet report, in accordance with a special embodiment of the present invention.

### DETAILED DESCRIPTION OF DIFFERENT EMBODIMENTS

In a spreadsheet application, data is displayed in a large number of individual cells which are arranged in rows and columns. The data cells or the data contained therein, respectively, may be part of a hierarchic structure, comprising different hierarchic levels. In particular, the data may be arranged in groups comprising so-called parent cells and child cells. Each of the parent cells and also the child cells—the latter may be “parents” as well—may be expanded so as to show one or more data cells of the next lower level, or collapsed so as to hide additional information. The user can, for example, by clicking on a certain control field like a “+” symbol for instance, manually toggle the display state of one or more cells from a collapsed to an expanded state, and by clicking on the same symbol again (which may have changed to a “−” symbol) back to a collapsed state.

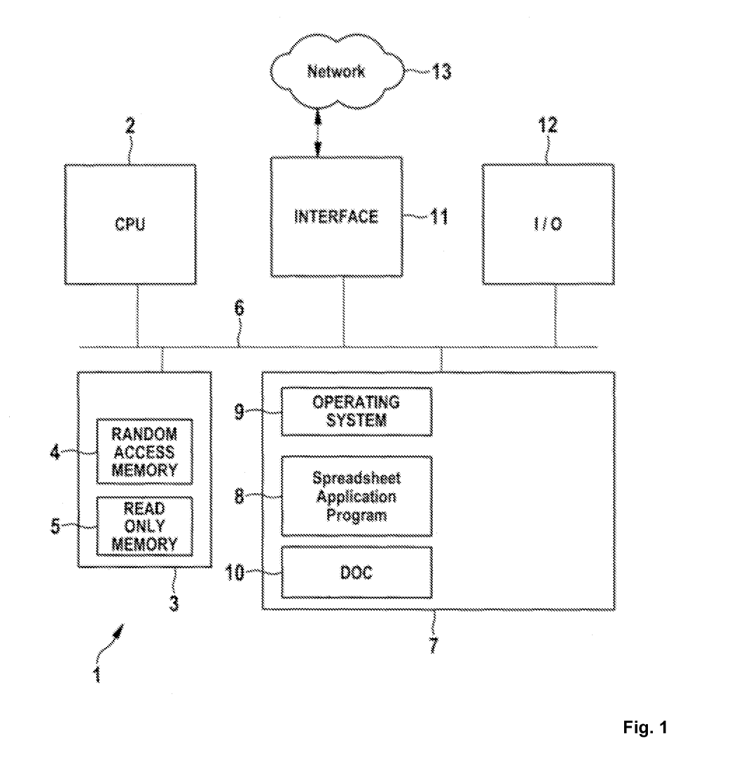

In a detailed description referring now to the drawings, various aspects of the invention will be described by way of example. In particular, FIG. 1 and the corresponding description are intended to provide a brief, general description of a suitable computing environment in which embodiments of the present invention may be implemented.

For the purpose of the present invention, any suitable type of computer system may be used including hand-held devices, desktop computers, laptops and the like. Distributed computing environments may also be used where tasks are preformed by remote processing devices that are linked through a communication network. In a distributed computing environment, program modules may be located in both local and remote storage devices.

In FIG. 1, an exemplary computer architecture for a computer 1 utilized in various embodiments is shown. The computer architecture of FIG. 1 may be configured in many different ways such as a server, a personal computer, a hand-held computer and the like. The computer 1 includes a central processing unit 2 (CPU), a system memory 3, including a random access memory 4 (RAM) and a read-only memory 5 (ROM) and a system bus 6 that couples the memory to the CPU 2. Some basic routines for data processing and for input/output-management may be stored in the ROM 5. The computer 1 further includes a hard disc 7, on which an operating system 9 and other application programs such as a spread sheet application program 8 may be stored.

The hard disc 7 is connected to the CPU 2 via the bus 6. Although the description of the mass storage device 7 refers to a hard disc, the storage device may be any other available storage medium that can be accessed by the computer 1.

In the illustrated embodiment, the computer 1 is connected to a network 13, such as the internet or a LAN, via a network interface 11. The computer 1 may also include an input/output controller 12 for receiving and processing input from a number of well-known devices, such as: keyboard, mouse, electronic pen and the like. Similarly, the input/output controller 12 may provide output to a display screen, a printer or some other type of device.

The storage device or a hard disc 7, respectively, and the RAM 4 may store a spread sheet application program 8 such as Microsoft Excel®. An exemplary spread sheet document is referenced by reference number 10.

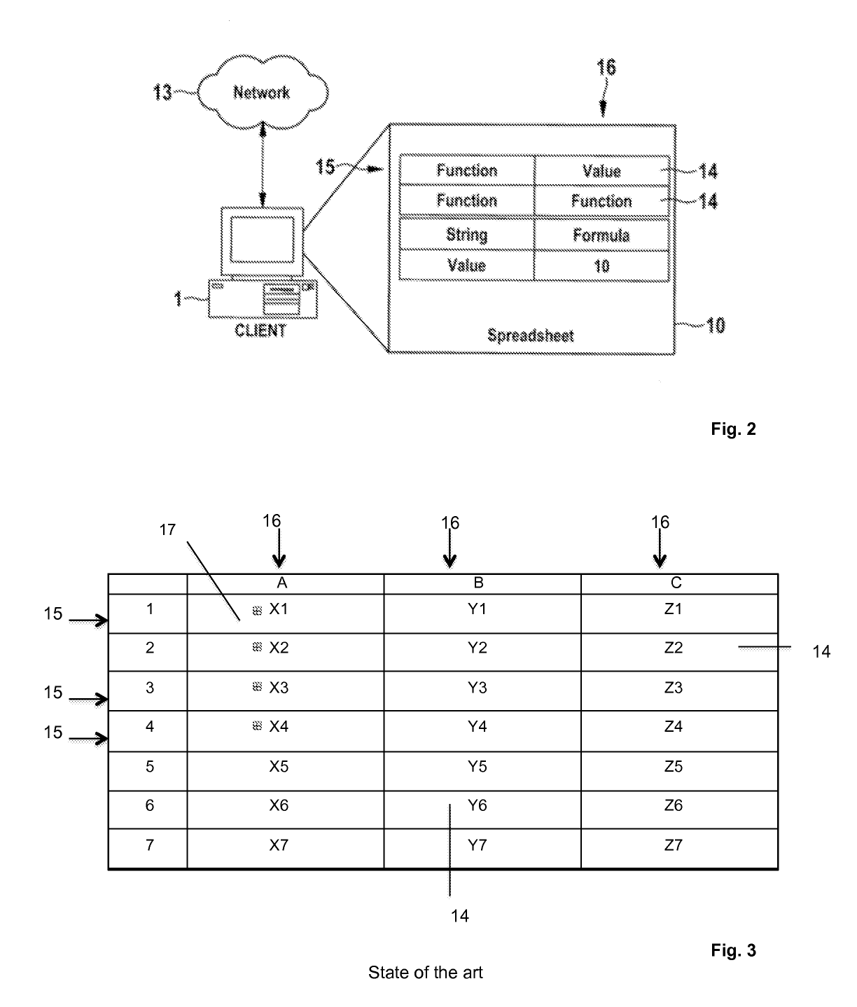

FIG. 2 illustrates an overview of a computer system comprising a client computer 1 which is connected to the network 13, such as the internet. On the computer 1, a spread sheet application program is run which displays a spread sheet on the computer screen. An enlarged view of the display is shown on the right hand side of the computer 1. In the illustrated example, a typical spread sheet, having a number of cells 14 which are arranged in rows 15 and columns 16, is shown. The user can enter any kind of data, like values, functions, strings or formulas, via a user interface, such as a keyboard. The user may further edit or process the data as desired. CPU 2 performs operations relating to the cells 14 within the spread sheet 10. A spread sheet 10 may be any regular spread sheet or any selection of data associated with a spread sheet or a data base, such as a so-called pivot-table or spread sheet report, respectively. In the present description and claims, any kind of sheet having a number of cells which are displayed in rows and columns, is referred to as a “spread sheet”.

FIG. 3 shows a typical spreadsheet report in a collapsed state in accordance with the state of the art. The spreadsheet comprises a number of cells 14 which are arranged in rows 15 and columns 16. In fact, the spreadsheet is much larger, but for purpose of clearness, only seven rows (1-7) and three columns (A,B,C) are shown. FIGS. 3-5 illustrate the expansion and collapse of data cells in a well known spreadsheet report.

Collapsed report 17 includes a number of parent cells, namely cells A1-A4, which are further expandable to show more detailed information. The characters X1-X4 each represent labels or headers of a group which may contain one or more child cells. In order to indicate the status of an expandable parent cell, a framed “+” symbol is shown in front of the data entry of each of the cells A1-A4. The cells A5-A7, including the data entries X5-X7, do not show such a “+” symbol, for they are not expandable. The other columns B and C contain data of any kind, like for instance numbers, characters or functions, among others.

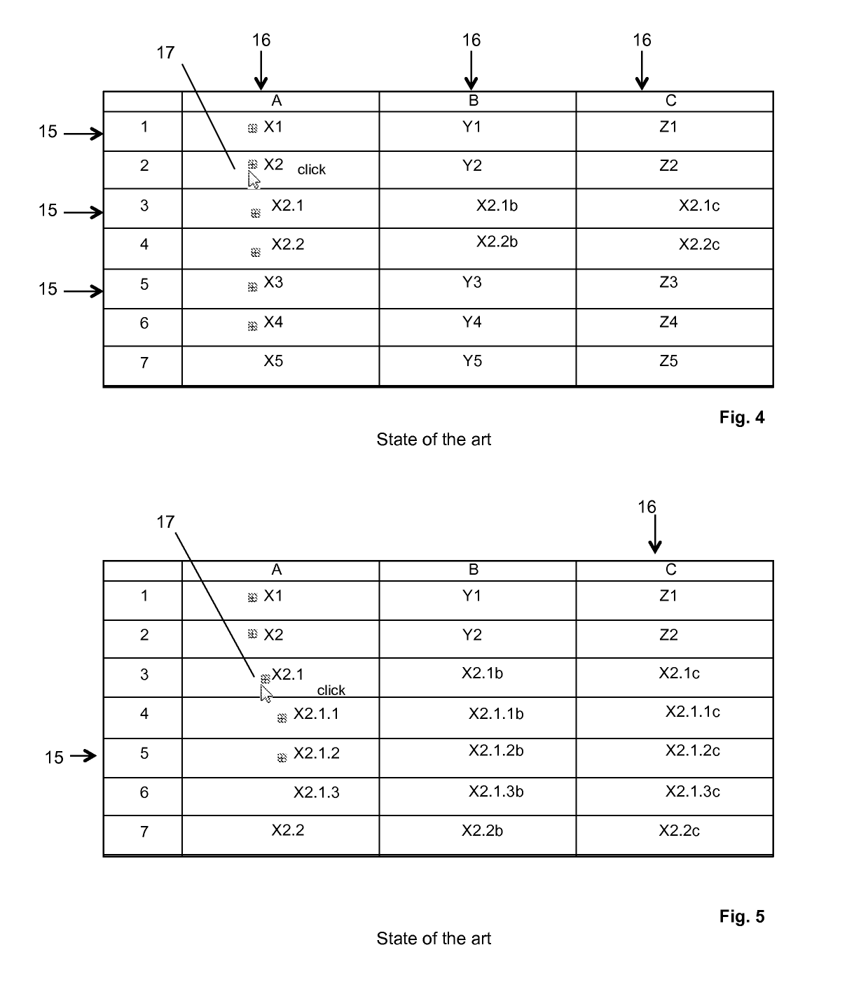

If a user wishes to expand parent member X2, he may click on the framed “+” symbol of cell A2, as shown in FIG. 4. In the spreadsheet, the mouse cursor 17 is located on the “+” symbol which is selected by clicking on the left mouse button. As a result, parent cell A2 is expanded and all of the child cells of the next level are displayed directly below the parent cell A2. In the present example, two child cells, A3 and A4 appear below the parent cell A2. Further, complete new rows 3 and 4 are displayed and filled with corresponding data. The previous rows 3 and 4, together with all of the subsequent rows, have been moved downward to give room to the new rows 3 and 4.

FIG. 5 shows the spreadsheet of FIG. 4 in a further expanded state. Therein, child cell A3, which is a parent cell, too, has been further expanded by clicking on the framed “+” symbol in front of the characters X2.1 of data cell A3. As can be seen in FIG. 5, three child cells A4-A6 have been automatically revealed. Therefrom, the cells A4 and A5 are further expandable. Data cell A6 is not expandable any further. Additionally, the corresponding data is shown in new rows 4-6.

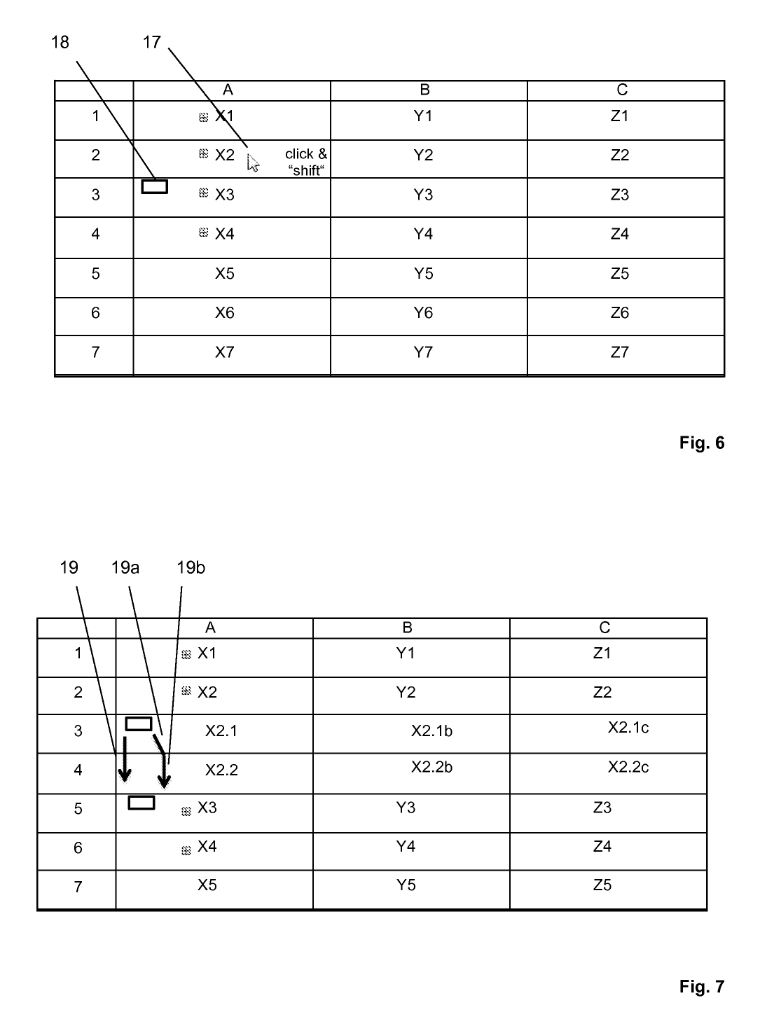

FIG. 6 shows a schematic illustration of a spreadsheet that has a number of expandable and collapsible cells A1-A4 according to an example embodiment of the invention. In the embodiment of FIG. 6, the data cells A1-A4 are expandable and the data cells A5-A7 are not expandable. If a user wishes to expand a data cell, for instance cell A2, and to reveal additional members of the group X2, he has to point with the cursor 14 on a cell (for instance A2), click the left mouse button and press the shift-key at the same time for instance. It is to be noted that any other user request may be programmed, like for instance double clicking, or pressing one or more keys and simultaneously clicking on the left or right mouse button, or, in case of a touch screen, touching the screen in the area of the cell (A2). In order to select a cell to be expanded, principally, the cursor or input device may be pointed at any position within the boundaries or directly onto a boundary of a data cell 14, like the lower boundary line of a cell.

When such a user request to expand a data cell has been recognized by the system, a tab or slider is displayed right below the data cell to be expanded, thereby indicating that this data cell (A2) may be expanded by a dragging movement. The user may then perform a dragging movement in a downward direction, starting from the current position of the cursor, or he may point on the tab 18 and start the dragging movement from that position. When performing the dragging downward movement, the user may keep the key(s) pressed or release a key, like for instance the shift-key. In a special embodiment, the user may point with the cursor or input device on the tab 18 and, in case of a mouse, press a mouse button and pull down the tab 18.

The dragging movement may be directed in any downward direction, like for instance a straight downward movement which is indicated by an arrow 19 in FIG. 7. In this embodiment, a straight downward dragging movement 19 will reveal one or more additional data cells of the next lower level, depending on the length of the movement, here cells A3 and A4, and complete new rows 3 and 4. In another embodiment, an angular or slanting downward movement, which is indicated by a path section 19a, has to be performed in order to reveal a data cell A3 of the next lower level. After having revealed a child cell and maybe also a grandchild cell, the user may change the direction of the dragging movement to a straight downward movement which is interpreted by the system to reveal one or more data cells of the same hierarchy level. In the present example, the user reveals one child cell, namely data cell A3, then changes direction of the dragging movement to a straight downward movement as indicated by path section 19b and reveals one more child cell, namely cell A4, which is of the same hierarchy level as data cell A3.

The angle of the sloped movement with a horizontal line may be between 20° and 60° or about 45° for instance. By performing a downward movement, the user may reveal one or more additional rows as desired, like using a roller blind. In order to collapse one or more of the rows, the user just needs to change direction of the movement and to conduct an upward dragging movement, thereby keeping all other states (like a mouse button or a key pressed).

If one or more rows or columns of a spreadsheet or a report, which is in an expanded state, shall be collapsed, a corresponding user request to collapse one or more cells has to be carried out. The user request for collapsing one or more of the cells 14 may be the same as for expanding a data cell, like for instance clicking on a data cell and pressing one or more additional keys, followed by an upward dragging movement. By performing the upward dragging movement, one or more of the rows disappear consecutively, depending on the current position of the cursor or input device. Thereby, the subsequent rows are moved upward automatically. Alternatively or additionally, collapsing of rows or columns may be carried out by another command, like for instance clicking or double-clicking on a cell which is to be collapsed, or on an icon, like a “−” symbol. Thereby all of the child cells of the selected cell are collapsed immediately.

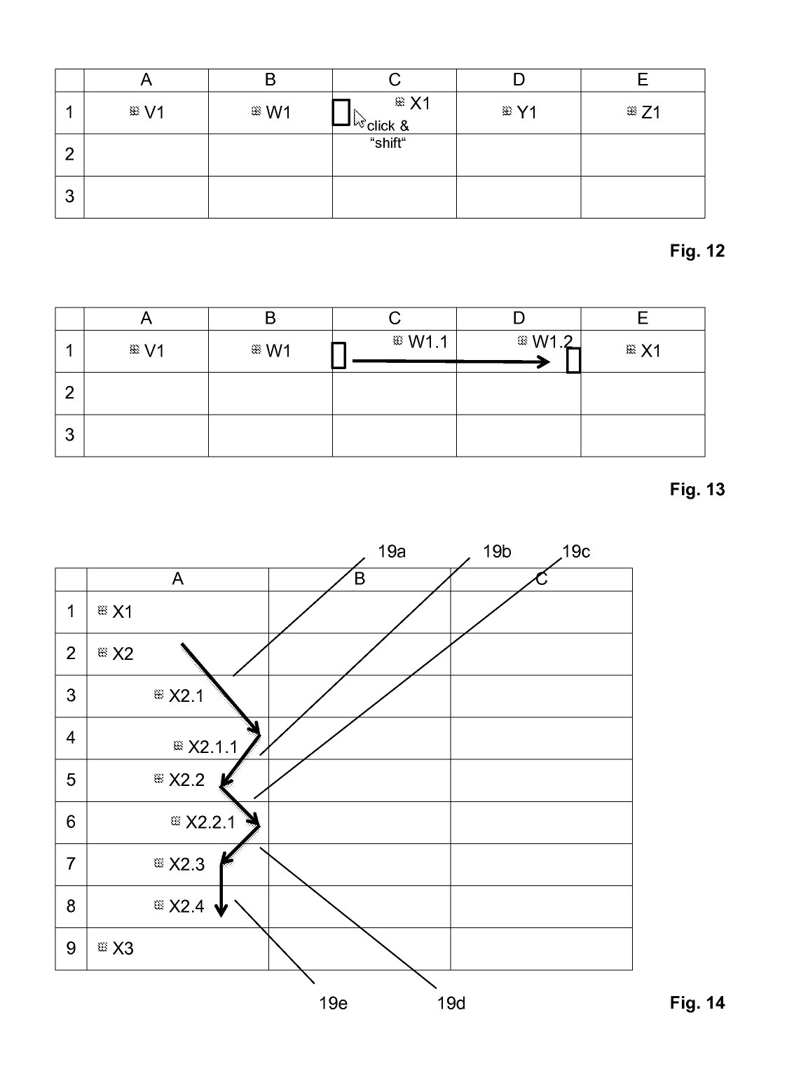

The same method may equally be implemented for the expansion and collapse of columns. As an example, the right borderline of a cell may be clicked on, thereby pressing an additional key, in order to instruct the system that a data cell shall be expanded and new columns shall be revealed. This will be explained later in relation to FIGS. 11 and 12.

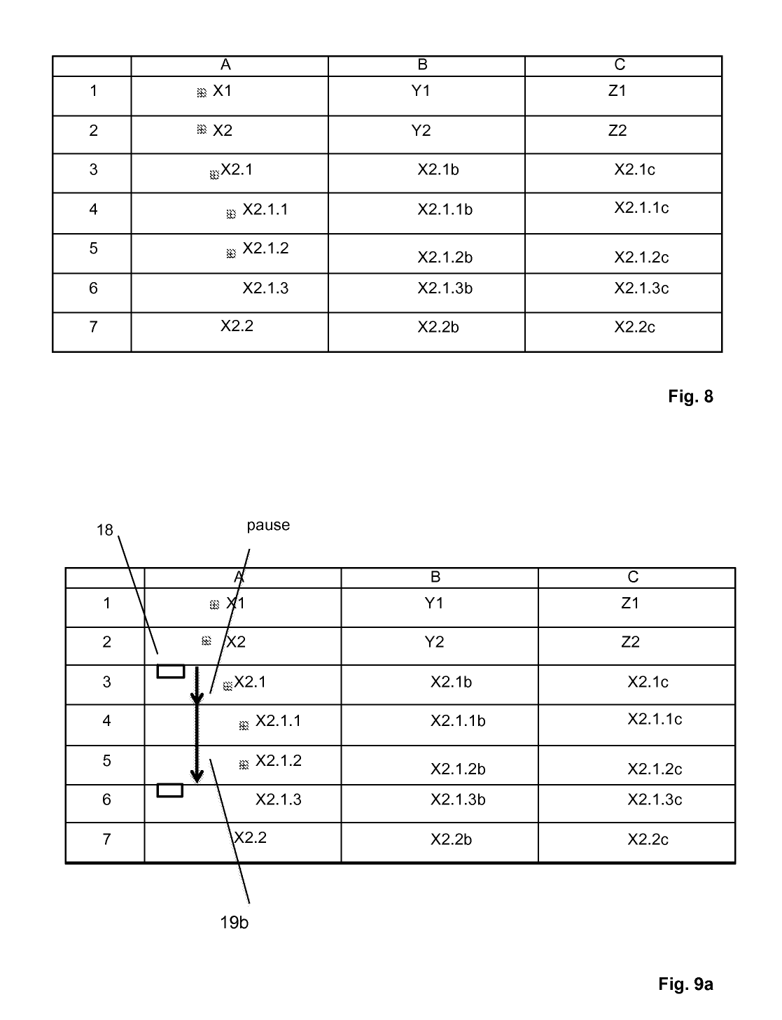

FIG. 8 shows an example embodiment of a spreadsheet including a parent cell A2 which has been expanded down to the third level. The data cell A2 may be referred to as a parent cell or data cell of a first level, cell A3 is a child cell or a data cell of a second level, as well as cell A7, and cells A4 to A6 are data cells of a third level. Thereby, level 1 is considered as being the highest level and level 3 the lowest level.

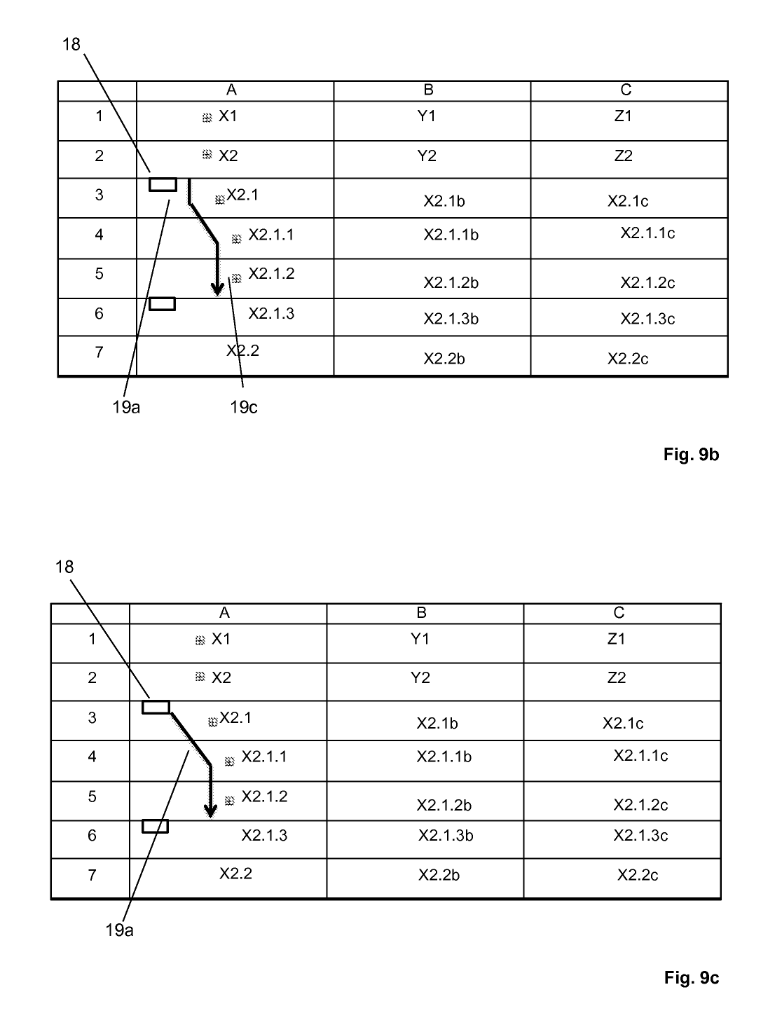

FIG. 9a-9c show different paths which may be followed by the user in order to expand the cell A2 to the state as shown in FIG. 8.

In a first embodiment of the invention, as shown in FIG. 9a, the user may follow a straight path downward which is interpreted by the system to reveal a child cell of the next lower level (level 2) directly below cell A2 and to insert a complete new row 3. Before crossing the lower borderline of newly displayed row 3, the user pauses his dragging movement within the boundaries of cell A3. Pausing the dragging movement is interpreted by the system as a command to expand the current cell A3 and to display a further child cell of a next lower level, i.e. level 3. Upon detecting such a user request, the current cell (A3) is expanded and a new child cell A4 is displayed directly underneath. The child cell (A4) of the next lower level may be displayed directly upon detecting a hold of the dragging movement, or when the dragging movement has crossed the bottom line of the cell to be expanded. The minimum time for pausing the dragging movement may be set to any desired value, like for instance to about half a second. After having paused the dragging movement for a brief instance, the user continues with a straight downward dragging movement according to path 19b. Thereby, child cells A4-A6 of the same hierarchy level are revealed and entire rows 4-6 are displayed, consecutively, in accordance with the position of the cursor or input means.

FIG. 9b shows another path which may be followed by a user in order to expand data cell A2 to the state as illustrated in FIG. 8. In this embodiment, the user again starts with conducting a user request to expand cell A2 followed by a straight downward dragging movement as indicated by path section 19a. Thereby, child cell A3 together with an entire row 3 is displayed. Before crossing the bottom line of newly displayed data cell A3, the user changes direction of his dragging movement to a sideward/downward movement under a sloped angle. This is interpreted by the system as a request to expand child cell A3 and display a new child cell A4 of the next lower level (level 3) and to enter a complete new row 4. The new child cell A4 is revealed on crossing the bottom line of data cell A3 for instance.

In general, the spreadsheet application software may be configured to display only entire rows or columns, having their final height or width, respectively, or to display portions of rows or columns. In a special embodiment of the invention, the new cells, rows or columns are displayed only partially up to the position of the cursor or input device, respectively.

After new row 4 has been partially or fully displayed, the user again changes direction of his dragging movement to a straight downward movement, as indicated by arrow 19c. The straight downward movement is interpreted by the system as a command to further expand parent cell A3 and to further reveal new child cells A5 and A6 of the same level as data cell A4, i.e. to stay on the same level.

FIG. 9c shows another path which may be followed by a user in order to expand data cell A2 to the state as illustrated in FIG. 8. In this embodiment, a slanted downward movement is interpreted as a command to further expand a cell and display one or more new cells of the next lower level. Starting from data cell A2, at first, child cell A3 and the entire row 3 is revealed. When continuing the slanted downward movement 19A, data cell A3 is further expanded and cell A4 of the next lower level (level 3) is revealed together with row 4. Then, within the boundaries of cell A4, the user changes direction of his dragging movement to a straight downward movement. Such a straight downward movement is interpreted by the system as a command to reveal new cells of the same level as the current cell. In the present example, new cells A5 and A6 having the same hierarchy level as cell A4 are displayed below data cell A4.

In order to collapse the spreadsheet back to the original display state, the user may perform just a straight upward dragging movement, or he may follow the path of the downward movement in the opposite direction, for instance.

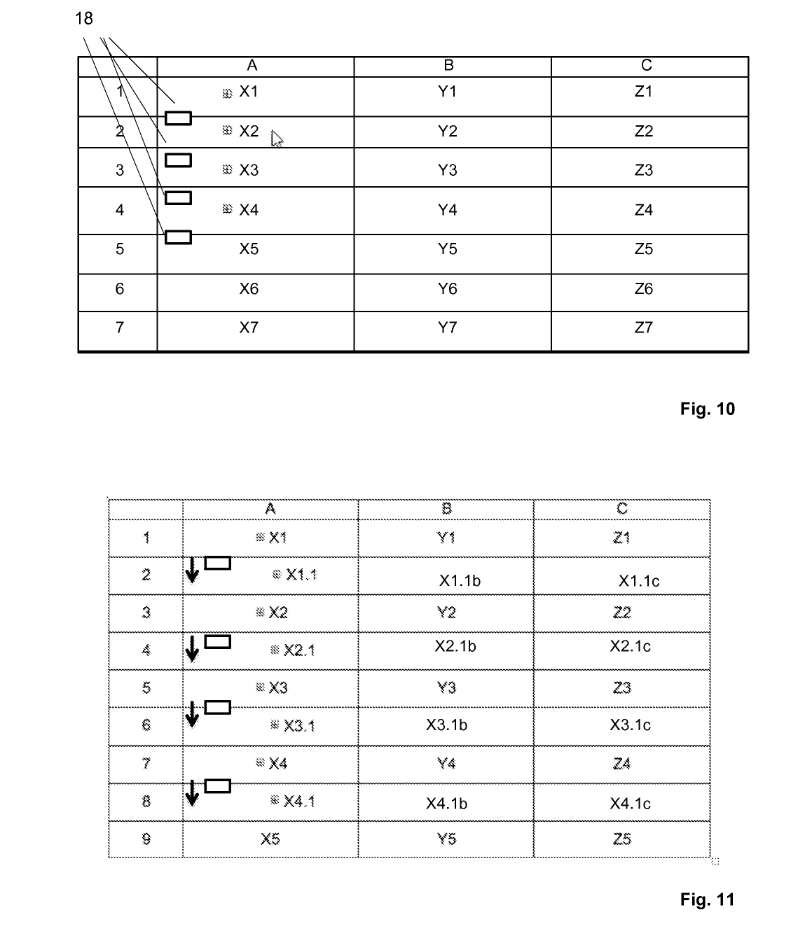

FIGS. 10 and 11 show the simultaneous expansion of several parent cells in a spreadsheet. In FIG. 10, the cells A1-A4 are expandable data cells and the cells A5-A7 are not expandable.

In order to display additional information associated with the data X1-X4, a corresponding user request has to be entered. Such a user request may comprise pressing a mouse button and one or more additional keys, double clicking the mouse and pressing one or more keys at the same time, clicking on a special icon which has been implemented for this purpose or entering any other kind of appropriate command. Recognition of such a user request may be indicated, e.g. by displaying a number of tabs 18 at the position of those cells which are expandable. Alternatively, any other kind of audible or visual indicator may be used. By performing a predetermined downward dragging movement, all of the data cells A1-A4 are expanded simultaneously and one or more additional rows are displayed below each of the cells A1-A4.

FIG. 11 shows the expanded display state of the parent cells A1-A4. In practise, the data X1-X4 may comprise names of projects, and the data X1.1, X2.1, X3.1 and X4.1 may be any associated information, like for instance working hours, holidays or sales figures.

FIGS. 12 and 13 show an example embodiment of a spreadsheet including expandable cells A1-E1. In the present example, data cell B1 shall be expanded and new columns C and D shall be revealed to present additional information. The expansion of a data cell is again started by conducting a user request, like for instance clicking on the right hand borderline of a desired cell, here data cell B1, while pressing one or more additional keys. The detection of such a command is interpreted as a user request to expand the corresponding cell and to display additional information in one or more newly created columns. When this software application recognizes a dragging sideward movement, one or more new columns are displayed proximate to the parent cell in column B. According to a special embodiment, the new columns are displayed only entirely with respect to their width. Alternatively, the columns may also be displayed partially, depending on the position of the cursor or input device. Like explained with respect to FIGS. 9a-9c, the direction of the dragging movement or pausing the dragging movement may be used as a command to control the level of expansion. In other words, by moving in a certain direction or by pausing the dragging movement, child cells of the same level, a lower level or a higher level may be revealed, or the number of columns may be diminished. In the example of FIG. 13, the user performs a straight sideward dragging movement in the direction of a row, thereby pressing the left mouse button.

FIG. 14 shows an example embodiment of a spreadsheet wherein data cell A2 has been expanded by following a special path 19a-19e. After having conducted a user request to expand data cell A2, a sloped dragging movement in direction right/downward will reveal a child cell A3 containing data of the next lower level.

As the slanted dragging movement is continued, also data cell A3 is expanded and a new child cell A4, which contains data of the next lower level, is displayed. The slanted movement is indicated by path section 19a.

The user may then desire to move up one hierarchy level and to display more information of the second hierarchy level (the same level as data cell A3) below cell A4. For this purpose, the user changes direction of his dragging movement to a direction left/downward. This is indicated by a path section 19b. Instead of changing the direction of the dragging movement, the user may alternatively enter any other command, like pressing a key while performing the dragging movement for instance.

The user then decides to expand data cell A5 and therefore performs a slanted dragging movement in the direction right/downward, thereby revealing new cell A6 (see path 19c). After that, the user returns to a movement in the direction left/downward and thereby displays a new data cell A7 containing data of the second level. This is indicated by a path section 19d. The subsequent straight downward movement, as indicated by path section 19e, finally reveals another child cell of the same level as the preceding cell A7.

The same principles also apply to the expansion or collapse of columns, wherein a left/right movement may correspond to up/down and the down movement to a sideward movement.

To a person skilled in the art, it is clear that the commands for expanding or collapsing of data cells are not limited to the given examples. Various modifications may be made without departing from the scope of the invention.

1. A method for expanding data cells in a spreadsheet or a report which is associated with a spreadsheet having a number of cells that are displayed in rows and columns wherein at least some of the cells may contain data which is member of a hierarchic structure comprising different hierarchic levels, the methods comprising the following steps:
detecting a user request to expand a certain cell, wherein the user request comprises the selection of a cell to be expanded,
further detecting a dragging movement performed by the user by means of an input means and
expanding the selected cell in reaction to the dragging movement, thereby displaying one or more cells proximate to the selected cell, depending on the length of the dragging movement.

2. The method of claim 1, wherein the one or more cells which are displayed proximate to the selected cell contain data which is of a different hierarchy level than the data of the expanded cell.

3. The method of claim 2, wherein the one or more cells which are displayed proximate to the selected cell contain data, the hierarchic level of which is at least one level lower than the expanded cell.

4. The method of claim 1, wherein, in reaction to a dragging movement, one or more entire lines or columns are displayed, depending on the length of the dragging movement.

5. The method of claim 1, wherein in reaction to a straight dragging movement of a given length, a corresponding number of new cells is displayed, wherein the newly displayed cells contain data of the same hierarchy level.

6. The method of claim 1, further comprising the step of detecting the direction of a dragging movement and, depending on the direction of the dragging movement, either displaying cells containing data of the same hierarchy level, or data of a different, in particular lower, hierarchy level.

7. The method of claim 1, further comprising the step of: during the process of expanding a selected cell in reaction to a dragging movement, detecting a user request to expand one of the newly displayed cells, and in reaction to the detection of such a request, expanding the selected newly displayed cell.

8. The method of claim 7, wherein the user request to expand one of the newly displayed cells comprises pausing the dragging movement for a given time, changing direction of the dragging movement, pressing a key or entering any other command.

9. The method of claim 1, wherein upon detecting a user request to expand a certain cell and detecting a dragging movement, the selected cell is expanded, thereby displaying one or more cells adjacent to the selected cell, wherein during the process of expanding the selected cell, a change of direction of the dragging movement is detected and interpreted as a request to select and expand the current cell, wherein, in reaction to the detection of a change of direction, the current cell is expanded, thereby displaying one or more cells adjacent to the newly selected cell.

10. The method of claim 1, wherein the new cells are displayed in new rows or columns, respectively, adjacent to the selected cell, and wherein the formerly adjacent rows or columns, respectively, are automatically moved aside.

11. The method of claim 1, wherein, upon detecting a user request to expand a certain cell, a symbol or control field is displayed which indicates to the user that performing of a dragging movement will result in an expansion of the selected cell.

12. A computer readable storage medium comprising a software application for expanding data cells in a spreadsheet or a report which is associated with a spreadsheet and having a number of cells that are displayed in rows and columns, wherein the software application comprises a code which executes the steps of:
detecting a user request to expand a certain cell, wherein the user request comprises the selection of a cell to be expanded,
further detecting a dragging movement performed by the user by means of an input means and
expanding the selected cell in reaction to the dragging movement, thereby displaying one or more cells proximate to the selected cell, depending on the length of the dragging movement.

13. The computer readable storage medium of claim 12, wherein the one or more cells which are displayed depending on the length of the dragging movement contain a data which is of a different hierarchy level than the data of the expanded cell.

14. The computer readable storage medium of claim 12, wherein the one or more cells which are displayed depending on the length of the dragging movement contain data, the hierarchic level of which is one level lower than the expanded cell.

15. The computer readable storage medium of claim 12, wherein, in reaction to a dragging movement, one or more entire lines or columns are displayed, depending on the length of the dragging movement.

16. The computer readable storage medium of claim 12, wherein in reaction to a straight dragging movement of a length of more than one cell, a corresponding number of new cells is displayed, wherein the newly displayed cells contain data of the same hierarchy level.

17. The computer readable storage medium of claim 12, further comprising the step of detecting the direction of a dragging movement and, depending on the direction of the dragging movement, either displaying cells containing data of the same hierarchy level, or data of a different hierarchy level.

18. The computer readable storage medium of claim 12, further comprising the step of: during the process of expanding a selected cell in reaction to a dragging movement, detecting a user request to expand one of the newly displayed cells, and in reaction to the detection of such a request, expanding the selected newly displayed cell.

19. A system for expanding data cells in a spreadsheet or a report which is associated with a spreadsheet having a number of cells that are displayed in rows and columns, comprising:
a processor and a storage medium;
a spreadsheet application configured to perform actions using the processor, the actions comprising:
detecting a user request to expand a certain cell, wherein the user request comprises the selection of a cell to be expanded,
further detecting a dragging movement performed by the user by means of an input means and
expanding the selected cell in reaction to the dragging movement, thereby displaying one or more cells proximate to the selected cell, depending on the length of the dragging movement.
